(19) United States
(12) Patent Application Publication
(10) Pub. No.: US 2022/0002107 A1
(43) Pub. Date: Jan. 6, 2022

(54) WEBTENSION TRANSDUCER LOAD CELL WITH INTEGRATED DATA INTERFACE

(71) Applicant: CSG Holding, Inc., Atkinson, NH (US)

(72) Inventors: Cynthia St. Peter, Atkinson, NH (US); Glenn St. Peter, Atkinson, NH (US); Andrew Losee, Madbury, NH (US); Keenan Wood, Dover, NH (US)

(73) Assignee: CSG Holding, Inc., Atkinson, NH (US)

(21) Appl. No.: 17/364,972

(22) Filed: Jul. 1, 2021

Related U.S. Application Data
(60) Provisional application No. 63/046,754, filed on Jul. 1, 2020.

(51) Int. Cl. B65H 23/04; G01L 5/10

(52) U.S. Cl. CPC B65H 23/044; G01L 5/10

(57) ABSTRACT

A tension transducer (also known as a tension load cell) contains a strain gauge signal conditioner and a data interface to transfer calibrated tension data over a data connection. Integration of signal conditioning allows for reduced system infrastructure within the tension control system, as no external amplifier is required for the tension transducer load cell. This also provides remote calibration and monitoring of the load cell for error conditions, directly through the data interface, with no reliance on external amplifier hardware. Additional integrated sensor information is sampled, and made available over the data connection, which may be pertinent to the web process. This includes load cell force direction orientation, internal temperature, excitation voltage, and raw load cell small-signal output voltage. The signal conditioning and diagnostic capabilities of the apparatus and method can be applied to any load cell device, and is not limited to web tension transducer load cells.

### RELATED APPLICATIONS

This application claims the benefit of U.S. Provisional Application No. 63/046,754, filed Jul. 1, 2020. This application is herein incorporated by reference in its entirety for all purposes.

### FIELD OF THE INVENTION

The invention relates to web tension control, specifically a tension transducer/load cell.

### BACKGROUND OF THE INVENTION

Tension transducer load cells are employed to measure the tension of a material in a web, rope, or cable format. These devices are often found in various manufacturing environments and on many types of machines, including extruders, laminaters, slitters, rewinders, sheeters, label makers, and other machines that process a continuous web of material. Web widths can range from many feet down to a single fiber strand or filament. Materials can include paper, films, plastics, felts, cloths, rubbers, metal, fibers, and others. Improper web tension in any of these cases can cause various problems in production, including slack web, web breakages, wrinkling, stretching, curling, crushed cores on rewind rolls, and other problems resulting in product waste or a finished product with quality issues. Therefore, web tension must be measured to prevent production problems. The tension transducer load cell is an essential for measuring tension force in a web material.

Traditional transducer load cells require external signal conditioning or amplification of the signal by an amplifier device, increasing system complexity and component count. The signal conditioning required by a load cell necessitates a small millivolt direct analog connection. This is susceptible to Electromagnetic Interference (EMI), ground loops, and static discharge. Machine designers must ensure the use of proper shielded cables and employ good grounding principles to achieve peak performance. While these limitations can be overcome, existing load cell amplifier installations also face other challenges when it comes to calibration. Many machines have multiple tension zones, or points of tension measurement. When commissioning a tension zone, the process often requires a user to press physical buttons at the applicable amplifier for each zone or location being calibrated.

Additionally, industrial plants today include network communication between various entities in the plant with a wide array of connected devices including controllable entities in the plant, such as motors and switches, valves, etc., and data collecting entities, such as sensors, to programmable logic controllers (PLCs) which, in turn, are connected to a human machine interface (HMI). No load cell transducers currently integrate this data connectivity capability into an integrated package.

FIG. 1 depicts components 100 from prior art U.S. Pat. No. 4,784,004 to Ekola and U.S. Pat. No. 5,113,709 also to Ekola showing current device configurations. U.S. Pat. No. 4,784,004 is an integrated roll tension transducer load cell assembly, where the U.S. Pat. No. 5,113,709 serves an identical purpose, but the roll assembly, including the shaft, must be provided by the customer.

What is needed is a device, system, and method integrating signal conditioning directly within a transducer load cell, providing a data connection, allowing remote calibration diagnostics and calibrated tension sampling, without the need for an external amplifier.

### SUMMARY OF THE INVENTION

An embodiment provides a tension transducer load cell device with an integrated data interface for remote calibration and monitoring comprising a host processor (1405); at least one strain gauge (225, 505) comprising a bridge (1445, 1505); an excitation power supply (1435); a 3-axis accelerometer (1415), whereby load cell force direction orientation is measured; an Analog to Digital Converter (ADC) (1540); and a signal conditioning circuit assembly (230, 1425, 1500); wherein load cell beams (215) have an induced stress in a structure of the beams which is measured using the at least one strain gauge (225, 505) which, in turn, generate a signal coupled to the signal conditioning circuit assembly (230, 1425, 1500); wherein integration of signal conditioning allows for reduced system infrastructure within the tension transducer load cell device; no external amplifier is employed for the tension transducer load cell; remote monitoring of the tension transduce load cell for error conditions is provided directly through the integrated data interface, with no reliance on external amplifier hardware; wherein additional integrated sensor information is sampled and made available over the data interface; and whereby the remote calibration and monitoring and diagnostic results are provided. In embodiments the device further comprises a roll (205, 515); bearings (210) on which the roll is mounted; load cell beams (215); means for holding the beams; a rigid shaft (220); and a mechanical fixed mounting. In other embodiments, the tension transducer load cell is a web tension transducer load cell. In subsequent embodiments the host processor (1405) executes a method for storing and retrieving calibration data from a memory storage device; and applies this calibration data to a raw load cell signal, producing a calibrated tension value. For additional embodiments the signal conditioning circuit assembly (230, 1425, 1500) comprises a Transient Voltage Suppressor (TVS) (1530); a positive sense terminal signal connection (1545); and a negative sense terminal signal connection (1550); and a communication processor (1410) and data interface to transfer calibrated tension data over a data connection. In another embodiment, sensors of the device provide remote monitoring of the load cell for error conditions directly through the data interface, with no reliance on external amplifier hardware; the remote monitoring comprising an uncalibrated status alarm (1900); an out-of-range status alarm (2000); a writing error status alarm (2100); an excitation short status alarm (2200); and an internal error status alarm (2300). For a following embodiment additional integrated sensors provide information pertinent to a web process is sampled and made available over the data interface, the additional integrated sensor information comprising the load cell force direction orientation; internal temperature; excitation voltage; and raw load cell small-signal output voltage. In subsequent embodiments load cell calibration comprises a calibration weight about 10% of a total range to be measured. In additional embodiments the signal conditioning circuit assembly (230, 1425, 1500) comprises a Wheatstone bridge.

Another embodiment provides a tension transducer load cell method with an integrated data interface for remote calibration and monitoring comprising providing a tension transducer load cell device comprising a host processor (1405); at least one strain gauge (225, 505) comprising a bridge (1445, 1505); an excitation power supply (1435); a 3-axis accelerometer (1415), whereby load cell force direction orientation is measured; an Analog to Digital Converter (ADC) (1540); a signal conditioning circuit assembly (230, 1425, 1500); and a communication processor (1410) and data interface to transfer calibrated tension data over a data connection; wherein load cell beams (215) have an induced stress in a structure of the beams which is measured using the at least one strain gauge (225, 505) which, in turn, generate a signal coupled to the signal conditioning circuit assembly (230, 1425, 1500); wherein integration of signal conditioning allows for reduced system infrastructure within the system; no external amplifier is employed for the tension transducer load cell; remote monitoring of the tension transducer load cell for error conditions is provided directly through the integrated data interface, with no reliance on external amplifier hardware; the remote monitoring comprising an uncalibrated status alarm (1900); an out-of-range status alarm (2000); a writing error status alarm (2100); an excitation short status alarm (2200); and an internal error status alarm (2300); whereby the remote calibration and monitoring and diagnostic results are provided. In included embodiments the uncalibrated status alarm (1900) comprises continuously monitoring commands for calibration (1935) by communications processor card (1410); monitoring communications for a determine zero tension command (1940); if there is a determine zero tension command, an ADC value is captured from the ADC (1540), and is saved to a memory (1945) to establish a zero value point; monitoring the communications for a calibrate tension command (1950); when the calibrate tension command is received, the calibrate tension command is processed to establish a second point (1955) of calibration, the calibrate tension value is captured from the ADC (1540), and is saved to memory (1955) to establish a calibration value point of a two-point calibration; if the tension transducer load cell is affirmatively calibrated, an Uncalibrated tension flag is cleared (1960); examining memory for a calibrated condition (1965); and if the tension transducer load cell is not calibrated, the Uncalibrated tension flag is set (1970). In yet further embodiments the out-of-range status alarm (2000) comprises calculating a tension value (2010) in host processor (1405); checking to see if the tension value exceeds 120% of a full range calibrated value (2015); if yes, a flag for an out of range condition is set (2025); if no, the tension value is again checked to see if it exceeds a value of −20% of a full range calibrated value (2020); if yes, the flag for out-of-range is set (2025); the flag for out of range clears (2030) upon a condition that previous range checks results are no, indicating that an out-of-range condition is no longer present. In related embodiments the writing error status alarm (2100) comprises sampling ADC tension values (2110); comparing the ADC tension values to a lower limit range of an expected signal (2115); checking an additional threshold for an upper value (2120); if the value exceeds an upper limit, then a Wiring Error Status Alarm flag is set (2125); if the value does not exceed the upper limit, then the Wiring Error Status Alarm flag is cleared (2130). For further embodiments the excitation short status alarm (2200) comprises sampling an excitation voltage at a +EXCV node via the host processor (2210); comparing the sampled excitation voltage to determine if it exceeds a lower limit (2215); if the sampled excitation voltage exceeds a lower limit, an Excitation Short error flag is set (2220), and steps return to the sampling excitation voltage (2210); if the sampled excitation voltage does not exceed the lower limit, the Excitation Short error flag is cleared (2225), and steps return to the step of sampling excitation voltage (2210). In ensuing embodiments the internal error status alarm (2300) comprises attempting communication with the ADC and a configuration of an ADC Write Command registers' operating parameters (2310); determining whether or not the communication is successful (2315); if the communication is not successful, an internal error condition is present, and a flag for internal error is set (2320), then steps return to step (2310); if communication is successful, the ADC command registers, which serve as a unique configuration signature, are queried to see if they are set correctly (2325); if successful and valid communication between the host processor and the ADC is occurring, any flags for internal errors are cleared and data is processed (2330). For yet further embodiments, the method measures a cantilevered roll. For more embodiments, load cell calibration measurement comprises a calibration weight about 10% of a total range to be measured. Continued embodiments include additional integrated sensor information pertinent to a web process is sampled and made available over the data interface, the additional integrated sensor information comprising a load cell force direction orientation; an internal temperature; an excitation voltage; and a raw load cell small-signal output voltage. For additional embodiments, force measurement is represented by:

$$F = 2 T sin ( \frac{{θ}_{w}}{2} ) sin ( {β}_{S} + {β}_{T} ) + W cos ( {β}_{S} )$$

where T is web tension, θω is a wrap angle, βs is a pitch angle, and βτ is a force direction angle.

A yet further embodiment provides a web tension transducer load cell system with an integrated data interface for remote calibration and monitoring comprising a host processor (1405); at least one strain gauge (225, 505) comprising a bridge (1445, 1505); an excitation power supply (1435); a 3-axis accelerometer (1415), whereby load cell force direction orientation is measured; an Analog to Digital Converter (ADC) (1540); a signal conditioning circuit assembly (230, 1425, 1500) comprising a Transient Voltage Suppressor (TVS) (1530); a positive sense terminal signal connection (1545); and a negative sense terminal signal connection (1550); a communication processor (1410) and data interface to transfer calibrated tension data over a data connection; a roll (205, 515); bearings (210) on which the roll is mounted; load cell beams (215); means for holding the beams; a rigid shaft (220); a mechanical fixed mounting; wherein the load cell beams (215) have an induced stress in a structure of the beams which is measured using the at least one strain gauge (225, 505) which, in turn, generate a signal coupled to the signal conditioning circuit assembly (230, 1425, 1500); wherein integration of signal conditioning allows for reduced system infrastructure within the system; no external amplifier is employed for the tension transducer load cell; remote monitoring of the load cell for error conditions is provided directly through the data interface, with no reliance on external amplifier hardware; the remote monitoring comprising an uncalibrated status alarm (1900); an out-of-range status alarm (2000); a writing error status alarm (2100); an excitation short status alarm (2200); and an internal error status alarm (2300); wherein additional integrated sensor information pertinent to a web process is sampled and made available over the data interface, the additional integrated sensor information comprising a load cell force direction orientation; an internal temperature; an excitation voltage; and a raw load cell small-signal output voltage; whereby the remote calibration and monitoring and diagnostic results are provided.

An embodiment provides a tension transducer load cell device with an integrated data interface comprising a host processor; a communication processor unit; at least one strain gauge; a strain gauge signal conditioner; a signal conditioning circuit assembly; a data interface to transfer calibrated tension data over a data connection; a roll; bearings on which the roll is mounted; load cell beams; means for holding the beams; a rigid shaft; a mechanical fixed mounting; wherein the load cell beams have an induced stress in a structure of the beam which is measured using the strain gauges which in turn generate a signal coupled to the signal conditioning circuit assembly; thereby producing a calibrated tension value. In embodiments the host processor executes a method for storing and retrieving calibration data from a memory storage device; and applies this calibration data to a raw load cell signal, producing a calibrated tension value. In other embodiments the host processor executes a method of communicating with, or is directly responsible for, a method of data communication processing to enable a data path between the device and a connected industrial network; wherein an established data connection improves noise immunity and eliminates ground loop issues. In subsequent embodiments the device comprises no external amplifier. For additional embodiments the tension transducer load cell is a web tension transducer load cell. In another embodiment the device executes a method to self-diagnose status conditions or errors within the device. For a following embodiment the device executes a method to self-diagnose status conditions or errors within the device based on diagnostics signal values obtained from host sensors. In subsequent embodiments host sensors gather information comprising orientation of the transducer load cell; temperatures at control circuitry; load cell excitation voltage; and transducer load cell output voltage. In additional embodiments processed signal data information comprises a particular value to monitor, or a summary format indicating a general operational status of the device, whereby self-diagnosed error conditions are shared over a data path. In included embodiments remote command functionality comprises an ability to zero or tare the device. Additional embodiments comprise a communication processor unit. In yet further embodiments remote command functionality comprises polling of diagnostics alarm error flags and collecting diagnostics information. In related embodiments data exchange methods comprise enabling alarm error flags; clearing alarm flags; viewing alarm flags; and hardware identification commands, whereby essential commands are performed comprising remote calibration without the need to locate a tethered amplifier and depress a button.

Another embodiment provides a method for integrating signal conditioning directly within a transducer load cell housing, providing a data connection, allowing remote calibration diagnostics and calibrated tension sampling, without a need for an external amplifier comprising starting; waiting for an established data connection; determining if the load cell is calibrated; if yes, continuously processing and reporting sensor data/status; and ending; if no, awaiting a calibration command/report uncalibrated status; then, when calibrated; continue on to continuously process and report sensor data/status; and producing a calibrated tension value. Ensuing embodiments comprise gathering sensor data designed to indicate tension with respect to a current material being run over the device; wherein tension data availability is dependent on a state of the device being calibrated and the presence of the established data connection. Yet further embodiments comprise self-diagnosing; and wherein a force on each beam of a load cell beam pair is summed. More embodiments comprise gathering information from host sensors comprising orientation of the transducer load cell; temperature of control circuitry; load cell excitation voltage; and transducer load cell output voltage. Continued embodiments include indicating potential failure reasons aiding troubleshooting of the device; determining when preventative maintenance is warranted thus minimizing downtime of the machine or system in which it's installed; zeroing or taring the device; polling of diagnostics alarm error flags and collecting diagnostics information; enabling alarm error flags; clearing alarm flags; viewing alarm flags; and commands identifying hardware.

A yet further embodiment provides a tension transducer load cell system with an integrated data interface comprising a host processor; a communication processor unit; at least one strain gauge; a strain gauge signal conditioner; a signal conditioning circuit assembly; a data interface to transfer calibrated tension data over a data connection; a roll; bearings on which the roll is mounted; load cell beams; means for holding the beams; a rigid shaft; a mechanical fixed mounting; wherein the load cell beams have an induced stress in the structure of the beam which is measured using the strain gauges which in turn generate a signal coupled to the signal conditioning circuit assembly; wherein integration of signal conditioning allows for reduced system infrastructure within the tension control system; no external amplifier is required for the tension transducer load cell; remote calibration is provided; remote monitoring of the load cell for error conditions is provided directly through the data interface, with no reliance on external amplifier hardware; additional integrated sensor information which may be pertinent to a web process is sampled and made available over the data connection; and wherein the signal conditioning and diagnostic capabilities of the apparatus and method can be applied to any load cell device; thereby producing a calibrated tension value.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter. The invention is susceptible of many embodiments. What follows is illustrative, but not exhaustive, of the scope of the invention.

### BRIEF DESCRIPTION OF THE DRAWINGS

FIG. 1 depicts prior art components from U.S. Pat. No. 4,784,004 to Ekola U.S. Pat. No. 5,113,709 also to Ekola.

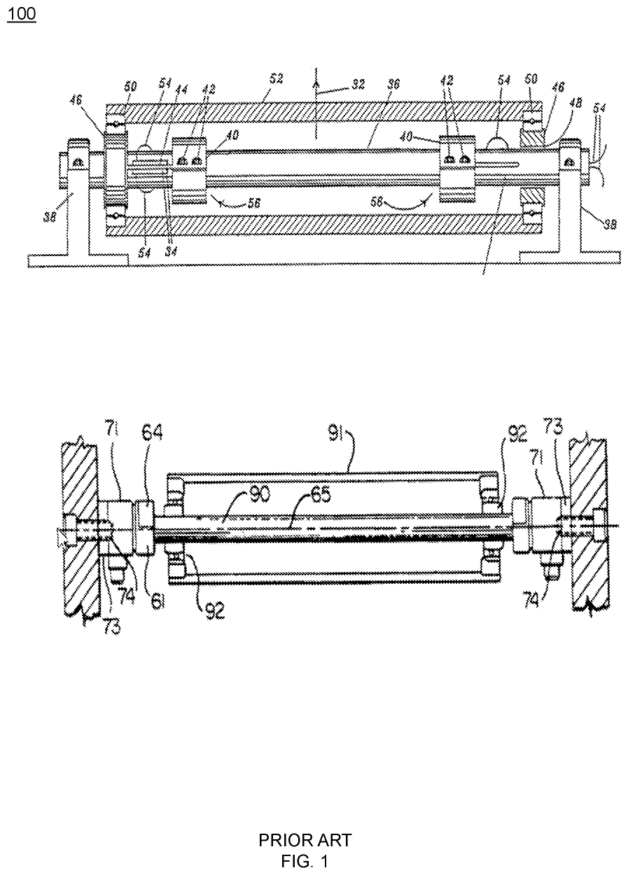

FIG. 2 depicts a webtension transducer load cell with integrated data interface side cross section view configured in accordance with an embodiment.

FIG. 3 depicts a web tension transducer load cell with integrated data interface perspective end view configured in accordance with an embodiment.

FIG. 4 depicts a device perspective interior view configured in accordance with an embodiment.

FIG. 5 depicts webtension transducer load cell with integrated data interface side views configured in accordance with embodiments.

FIG. 6 is a webtension transducer load cell with integrated data interface side cross section detail view configured in accordance with an embodiment.

FIG. 7 depicts webtension transducer load cell with integrated data interface axial end views configured in accordance with embodiments.

FIG. 8 depicts a webtension transducer load cell with integrated data interface side cross section views configured in accordance with embodiments.

FIG. 9 depicts a load cell orientation force direction and tension force alignment diagram configured in accordance with an embodiment.

FIG. 10 depicts a load cell pitch orientation sensing and weight force reference diagram configured in accordance with an embodiment.

FIG. 11 depicts a load cell pitch orientation sensing and tension force reference diagram configured in accordance with an embodiment.

FIG. 12 depicts load cell status alarm pitch reference diagrams configured in accordance with embodiments.

FIG. 13 is a wiring schematic block diagram configured in accordance with an embodiment.

FIG. 14 is a system block diagram configured in accordance with an embodiment.

FIG. 15 is a signal conditioning circuit (load cell raw small-signal) diagram configured in accordance with an embodiment.

FIG. 16 is a load cell excitation schematic diagram configured in accordance with an embodiment.

FIG. 17 is a flowchart of a method configured in accordance with an embodiment.

FIG. 18 is a status alarm—pitch orientation method flowchart configured in accordance with an embodiment.

FIG. 19 is a status alarm—uncalibrated method flowchart configured in accordance with an embodiment.

FIG. 20 is a status alarm—out of range method flowchart configured in accordance with an embodiment.

FIG. 21 is a status alarm—wiring error method flowchart configured in accordance with an embodiment.

FIG. 22 is a status alarm—excitation short method flowchart configured in accordance with an embodiment.

FIG. 23 is a status alarm—internal error detection method flowchart configured in accordance with an embodiment.

### DETAILED DESCRIPTION

A device and method is needed for integrating signal conditioning directly within a transducer load cell, providing a data connection, allowing remote calibration diagnostics and calibrated tension sampling, without the need for an external amplifier. Many of these issues are resolved by integrating signal conditioning directly within the transducer load cell, providing a contemporary industrial protocol interface data connection, allowing remote calibration diagnostics and calibrated tension sampling. This provides tension force data without the need for an external amplifier, while also providing modern diagnostics information needed for a new generation of connected factories, machines and subsystems. By the present invention it is now possible to support this modern connectivity technique and integrate transducer load cells into machines and systems as part of the networked infrastructure.

A tension transducer load cell with an integrated data interface is described. Embodiments include a method to provide a calibrated tension force measurement over a data connection in a desired format. Such formats can comprise a known protocol, including one or more public, proprietary, or yet to be developed protocols. Nonlimiting protocol examples include Profibus (Process Field Bus), Controller Area Network (CAN), DeviceNet, CANopen, PROFINET, IO-Link, EtherNet/IP, EtherCAT, Modbus TCP, CC-Link IE Field, Powerlink, BACnet/IP, and Common Industrial Protocol (CIP). An advantage of these embodiments is that modern communication protocols can be used to interface directly to the load cell transducer, reducing system component counts by bypassing an external amplifier.

Embodiments include a device having a host processor executing software with a method for sampling raw strain gauge small-signal voltages from the transducer load cell. The host processor further executes a method for storing and retrieving calibration data from a memory storage device, and applying this calibration data to the raw load cell signal, thus producing a calibrated tension value. In embodiments, the host processor also executes a method of communicating with, or is directly responsible for, a method of data communication processing to enable a data path between the device and the connected industrial network. An advantage of this embodiment is that the established data connection improves noise immunity and eliminates ground loop issues. This is because the small-signal level conditioning only occurs locally, within the transducer load cell, and no longer requires an external amplifier.

Embodiments include a device executing a method to self-diagnose certain pertinent status conditions or errors within the device. This is based on diagnostics signal values obtained from host sensors. Host sensors serve to gather information such as, but not limited to, orientation of the transducer load cell, temperatures of the device's control circuitry. Information further includes orientation data, load cell excitation voltage, and transducer load cell output voltage. In addition, embodiments provide a method for processing these signals and making that data available on the data interface in the form of usable information. In embodiments, this information comprises a particular desired value to monitor, or a summary type format to indicate the general operational status of the device. An advantage of this embodiment is that self-diagnosed error conditions can be shared over the data path. This could indicate potential failure reasons aiding troubleshooting of the device, or data could be used to determine when preventative maintenance is warranted thus minimizing downtime of the machine or system in which it's installed.

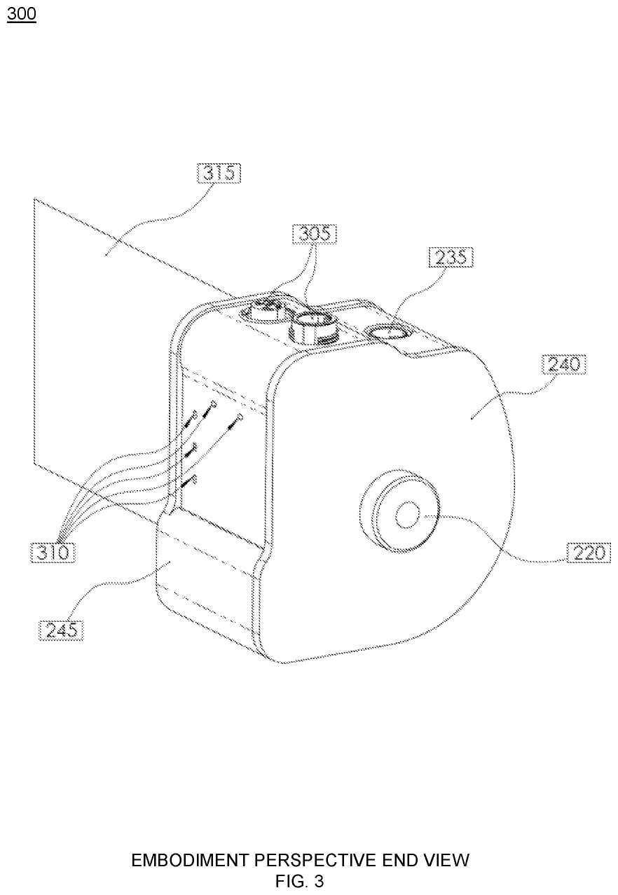

Embodiments include a device executing a method to process remote commands for calibration. Remote command functionality includes the ability to zero or tare the device. Device connection embodiments allow for polling of diagnostics alarm error flags and collecting diagnostics information. Additional data exchange methods for enabling alarm error flags, clearing alarm flags, viewing alarm flags, or other necessary functions related to the functionality of the transducer load cell, including hardware identification commands are included. An advantage with this embodiment is the ability to perform essential commands such as calibration remotely, without the need to locate a tethered amplifier and depress a button. Remote calibration by command can enable efficient machine commissioning by guided processes dictated by system control rather than an operation manual. Hardware identification commands can prove useful by forcing the load cell transducer to pulse status LEDs or indicator light (FIG. 3) 310 to aid in the physical identification during maintenance routines, commissioning, calibration, or other operational modes including those of error.

Briefly summarizing, all transducer load cell amplification and signal conditioning functionality which would typically be performed by an external amplifier or signal conditioner is performed within the confines of transducer load cell housing. Additionally, a direct connection supported by an industrial data interface is supported to provide tension force data without the need for an external amplifier, while also providing modern diagnostics information needed for a new generation of connected factories, machines and subsystems.

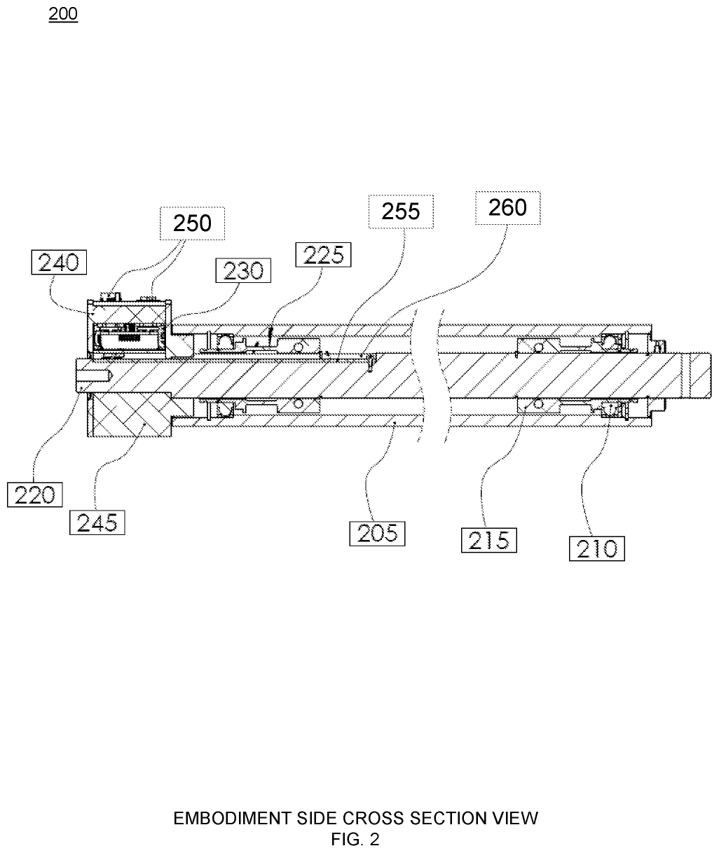

FIGS. 2-8 depict views of embodiments.

Referring now to FIG. 2, a webtension transducer load cell with integrated data interface cut away side view 200 comprises a transducer load cell including a roll 205 which sits on bearings 210. Tension from the material passing over the roll 205 is then transferred to load cell beams 215. The beams 215 are held rigid on shaft 220 which is held ridged by a machine frame or other mechanical fixed mounting techniques. The load cell beams 215 have an induced stress in the beam structure from the tension of the material running over the roll 205 which is measured using strain gauges 225 which in turn generate a signal coupled to a signal conditioning circuit assembly 230. Also depicted are data interface connectors 250; connector housing 240; and connector housing clamp 245. Wire channel keyway 255 and the wire connection solder pad terminals to which the load cell connection wires are attached 260 are also depicted.

FIG. 3 depicts a different view of the same embodiment of the webtension transducer load cell with integrated data interface 300. The embodiment shown is supported by a rigid support shaft 220 supported on both ends by support clamps or machine frame. Power is provided to the data interfere of the embodiment via a power connector 235 and a data connection is established via the data interface connectors 305. The data connections may also be wirelessly coupled to the connected device so that the need for data interface connectors 305 may be rendered unnecessary. The signal conditioning and data interface electronics are housed in the connector housing 240. An indicator light 310 is used to identify system status errors or other operational necessities requiring indication. Also depicted are the roll 315; and connector housing clamp 245.

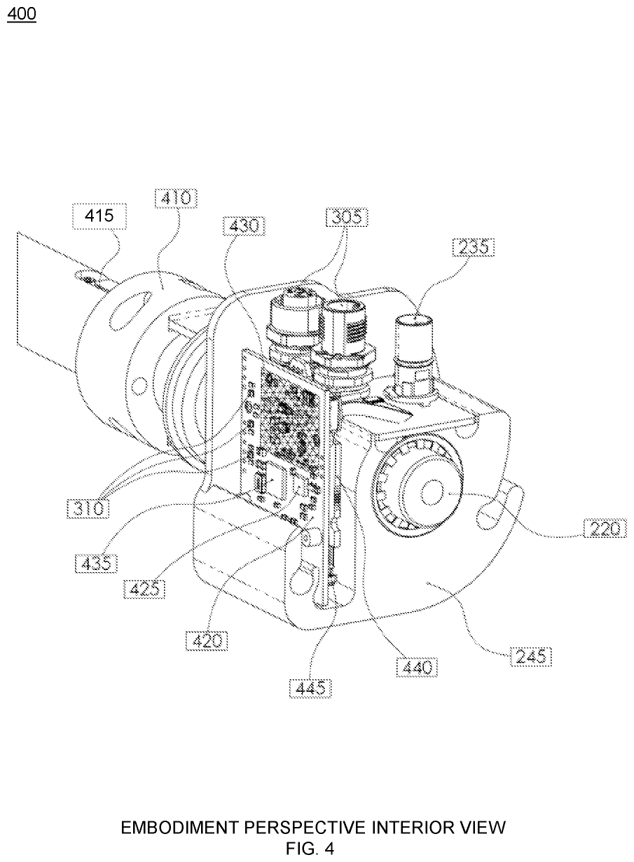

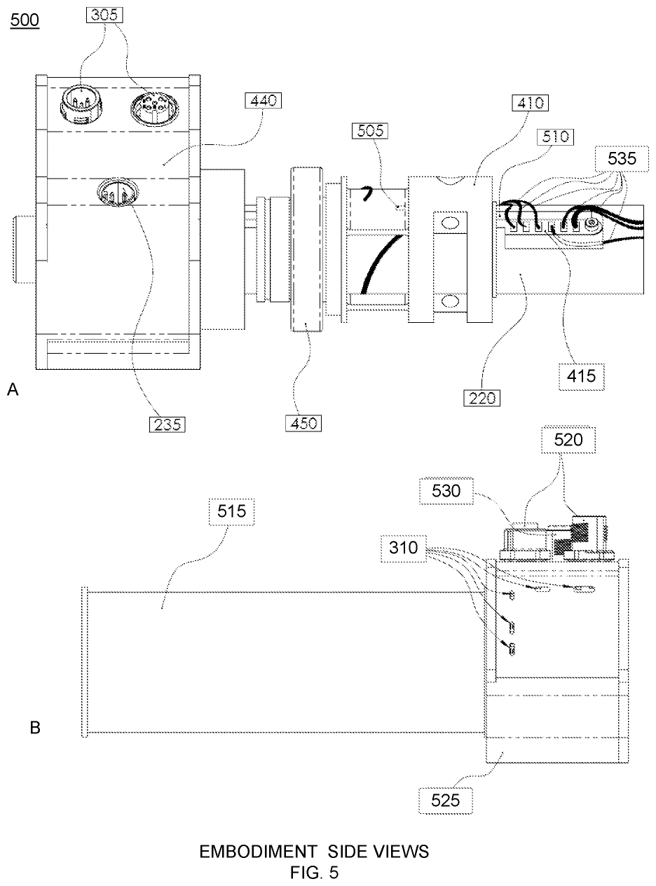

FIGS. 4 and 5 depict views of an embodiment.

FIG. 4 depicts a device interior 400. Shown are the wired connection solder pad terminals 415 to which the load cell connection wires are attached to complete the connection to the load cell beams 410 which carry the analog signal from the strain gauge (FIG. 5, 505), These conductors, which are connected to the wire connection solder pad terminals wired connections 415, pass through the wire channel keyway (FIG. 2, 255, FIG. 5, 510), to the signal conditioning circuit card 420 which is responsible for signal conditioning of all system sensors including the load cell strain gauge sensors (FIG. 5, 505). An inertial senor 425 is utilized to monitor device orientation. Analog sampling circuitry 430 is used to amplify and sample raw signals from the load cells which are then converted to tension signals once the system is calibrated. The host processor 435 is responsible for all system operation pertaining to sampling sensor data and, in this embodiment, is used to store calibration data for the load cells. The host processor 435 communicates with the communication processor card 440 via the communication processor unit connector 445. The communication processor unit 440 provides the data interface to the web tension transducer load cell via the data interface connectors 305. Power is provided via a power connector 235, unless the embodiment is powered utilizing power over Ethernet, in which case power connector 235 is omitted and power is transferred directly through data interface connectors 305.

FIG. 5 depicts views 500 of FIG. 4 device interior, embodiments A and B. Also shown are wired connections 535 to the load cell beams 410 in which load cell strain gauge sensors 505 are affixed. Also depicted are load cell roll bearing 450; channel keyway 510 to route the necessary electrical connections, the wire connection solder pad terminals 415, and shaft 220. Embodiment B depicts a cantilever embodiment in which the cantilever type provides a mounting configuration which relies on only one end being mounted to a rigid frame. This mounting configuration is ideal for single sided machine frame designs, as the roll hangs horizontally and is only supported at one end. The mounting is performed on the connector housing 525 side of the unit. The cantilever roll 515 is included as an integrated component of this embodiment and is not customer provided. The cantilevered roll 515 hangs horizontally and freely away from the machine frame, and allows for internal routing of load cell conductors. Also shown are data connections 520 and power connection 530, allowing the embodiment to be mounted from the connector housing 525 side solely. Also shown are status indicator lights 310.

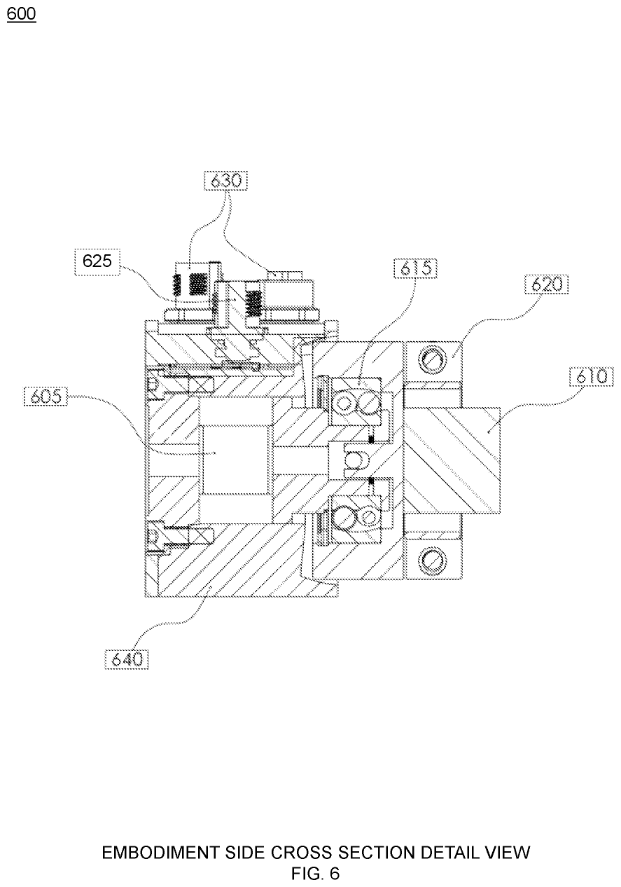

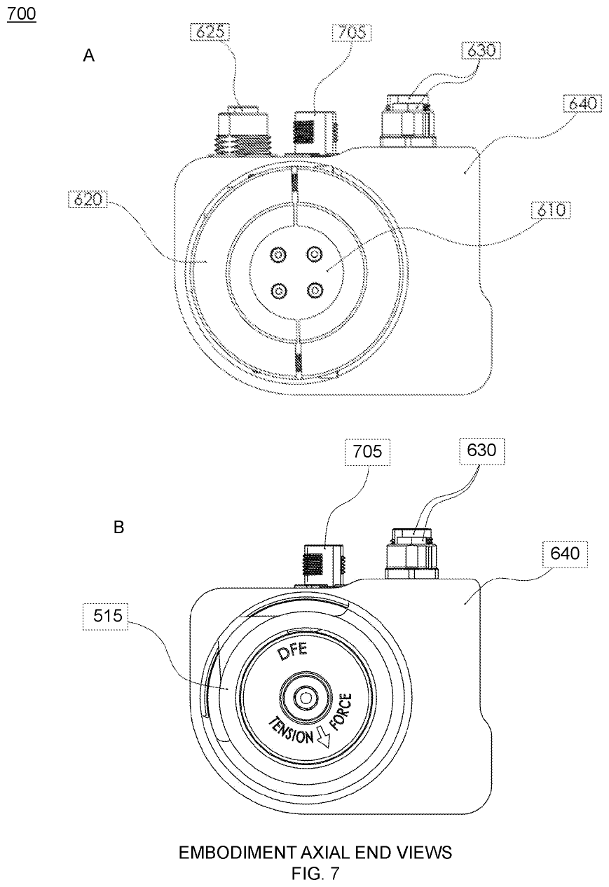

FIGS. 6, 7, embodiment A, and 8, embodiment A depict embodiments where the roll and shaft are provided by the customer.

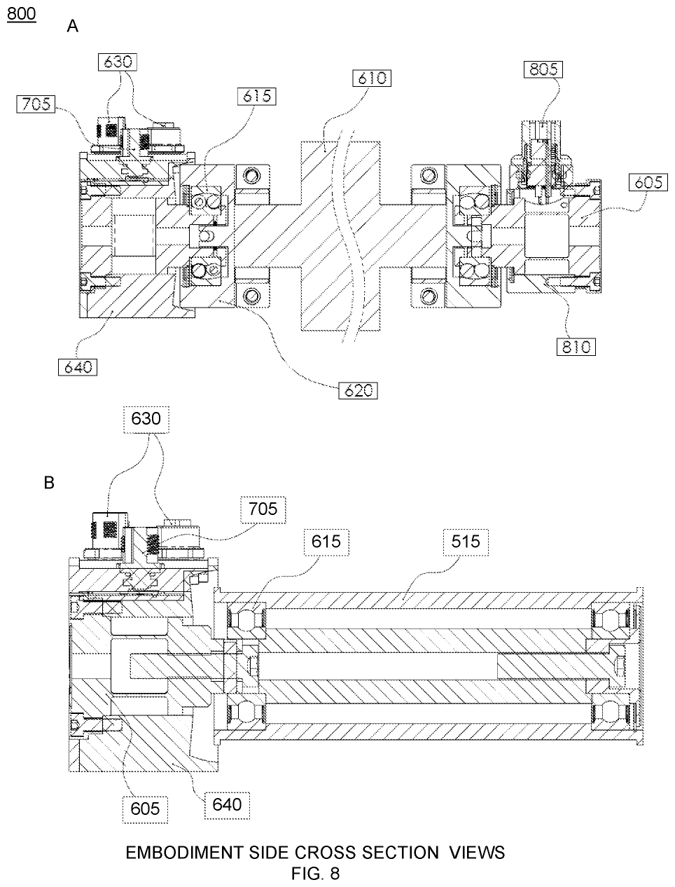

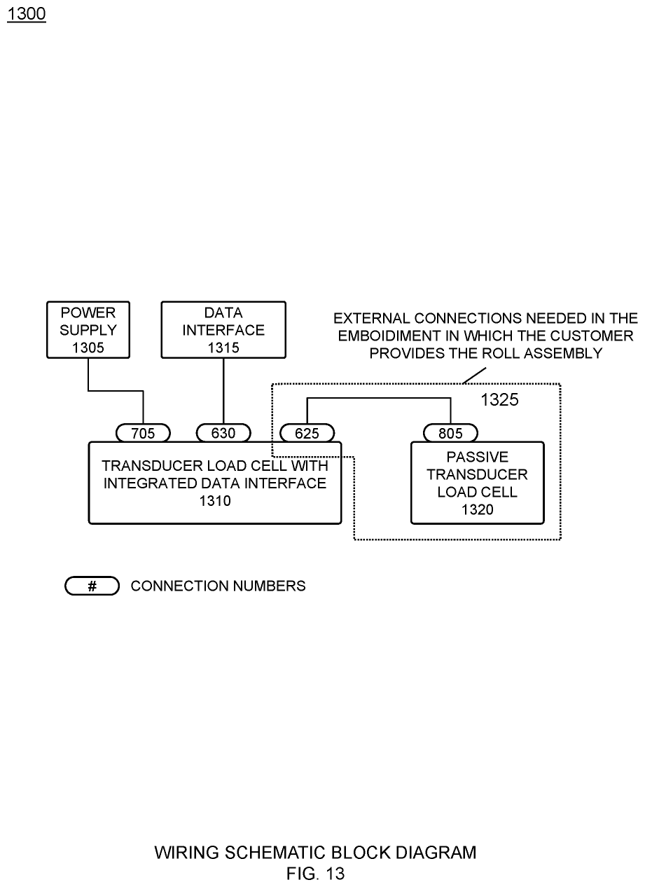

FIG. 6 embodiment cut away view 600 comprises load cell beam pairs (one shown) 605, usually separated by some distance and installed on opposing sides of the machine frame or installation. A shaft 610 is used as a supporting member for the roll as shown in FIG. 8, embodiment A, where, in this embodiment, the shaft and roll 610 assembly is provided by the customer. The shaft 610 transfers force through the bearings 615 to the load cell beam 605 via the shaft coupling 620. As the tension measurement requires the force on each beam 605 to be summed, there is a necessary additional connector 625 added to this embodiment which provides for a conduit to be connected. The conduit carries the non-signal conditioned load cell tension signals from the passive side connector (FIG. 8, embodiment A, 805) to the active side connector 625 thus, only one side need contain the data connection 630 and power connection (FIG. 7, 705). A schematic of these connections can be found in FIG. 13. Also depicted is connector housing 640.

FIG. 7 depicts orthogonal end views 700 of embodiments A and B. FIG. 7 embodiment A is an orthogonal end view for the embodiment of FIG. 6. It comprises load cell beam pairs, usually separated by some distance and installed on opposing sides of the machine frame or installation. A shaft 610 is used as a supporting member for the roll as shown in FIG. 8, embodiment A, where, in this embodiment, the shaft and roll 610 assembly is provided by the customer. The shaft 610 transfers force through the bearings to the load cell beam 605 via the shaft coupling 620. As the tension measurement requires the force on each beam to be summed, there is a necessary additional connector 625 added to this embodiment which provides for a conduit to be connected. The conduit carries the non-signal conditioned load cell tension signals from the passive side connector (FIG. 8, 805) to the active side connector 625 thus, only one side need contain the data connection 630 and power connection 705. Also depicted are connector housing 640; and roll shaft assembly 610 provided by the customer. Embodiment B depicts a cantilever embodiment which is an orthogonal end view of the embodiment of FIG. 5, embodiment B. Certain installations require machine frame mounting on only one side of the frame; this embodiment provides a solution. In this embodiment, cantilever roll 515 is included as an integrated component, allowing the embodiment to be mounted from the back side of the connector housing 640 side, solely. Different from FIG. 7, embodiment A, the Active Side Connector 625 is omitted, as all wiring for load cell beams are internally routed within the provided integrated cantilever roll 515.

FIG. 8 depicts side cut away views 800 of embodiments A and B. FIG. 8, embodiment A, is an embodiment side cut away view showing both sides of the previous embodiment shown in FIGS. 6 & 7, embodiment A, where the customer provides the roll shaft assembly 610. Passive side connector 805 is shown and is connected to the active side connector 625 in order to provide a conduit such that the Analog sampling circuitry which resides in the connector housing 640 can sum both load cell signals from both the active connector housing 640 side, and the passive connector housing 810 side of the assembled system. Active shaft coupling 620 is also depicted. Embodiment B depicts a cantilever embodiment which is a cut away view of FIG. 5 embodiment B, in which cantilevered roll 515 is an integrated component that mounts on bearings 615 and which transfers force to load cell beam 605. To meet single side machine mounting requirements, only the connector housing 640 is used for mounting the device, allowing cantilevered roll 515 to hang horizontally and freely away from the machine frame. Also shown are data connections 630 and power connection 705.

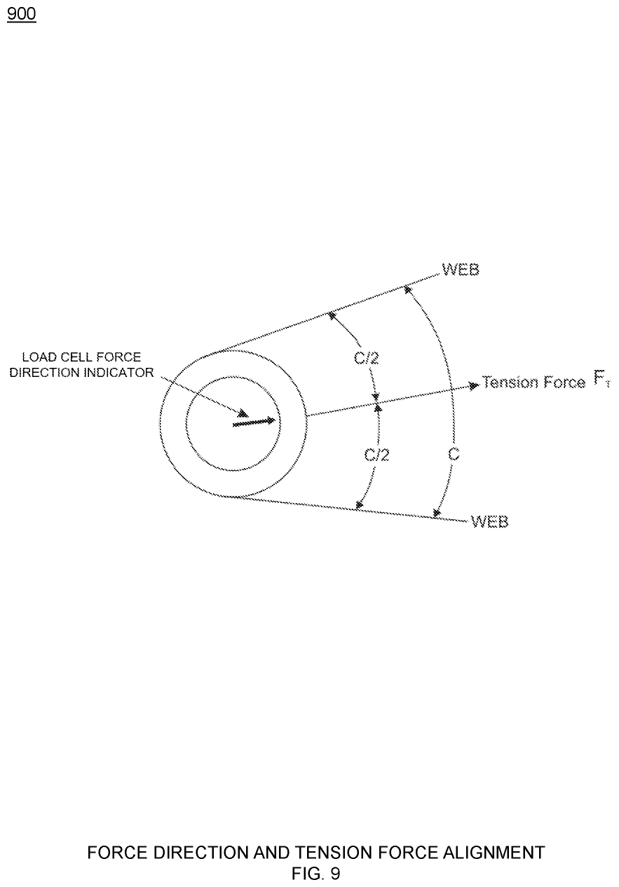

FIGS. 9-12 depict orientation alignment for embodiments.

FIG. 9 depicts force direction and tension force alignment 900. The load cell Tension force direction is determined by the web and more specifically, the web wrap angle. The web tension force can be resolved by defining the tension wrap angle C. At which C/2, the Tension force direction, is established. For a proper installation, the Tension force of the web shall always align in the direction of the transducer load cell force direction indicator.

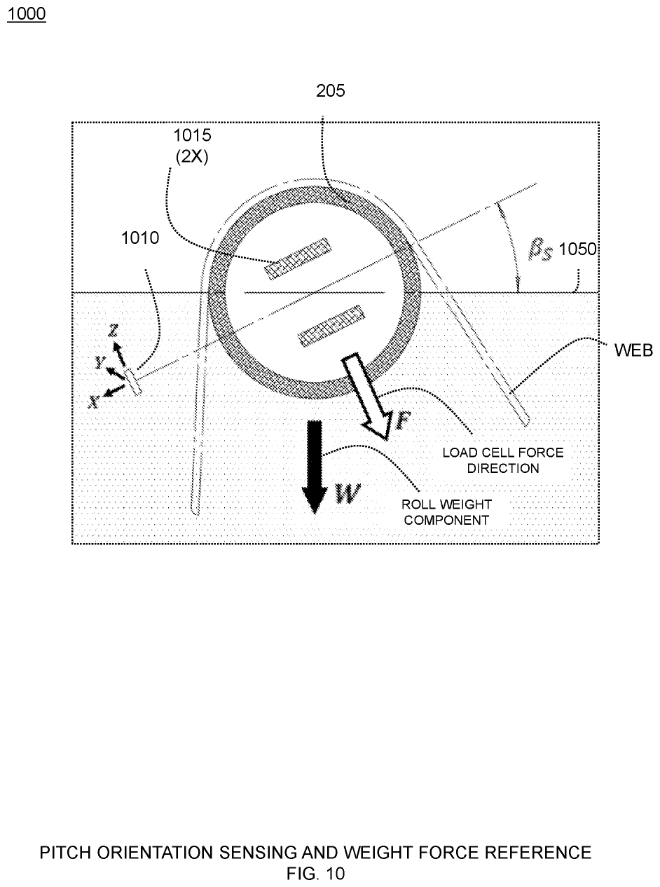

FIG. 10 depicts a load cell pitch orientation sensing and weight force reference diagram 1000, showing roll 205. To obtain orientation of the load cell, a 3-axis accelerometer is used in a standard practice to determine pitch by measuring the gravitational acceleration in 2 axes. FIG. 10 is a simplified end view of an embodiment which shows the accelerometer (1010) in a particular orientation in which the X-axis orientation is parallel with the transducer load cell beams (1015) and the Z-axis of acceleration is normal to the established X-axis. In embodiments, a direct relationship between load cell force direction and the orientation of the accelerometer is established such that the load cell force direction is always in the axial direction of the accelerometer Z-axis which is set to be normal to the beam orientation during assembly.

The accelerometer determines pitch angle βs relative to the horizon (1050), while the load cell force direction can be determined to be normal to the X-axis shown in FIG. 10 as the Load cell force direction F. Proper orientation of the beam during assembly with respect to the accelerometer allows the Load Cell Force Direction F to always be normal to the calculated pitch angle of the system, and it can easily be obtained by sampling the onboard accelerometer.

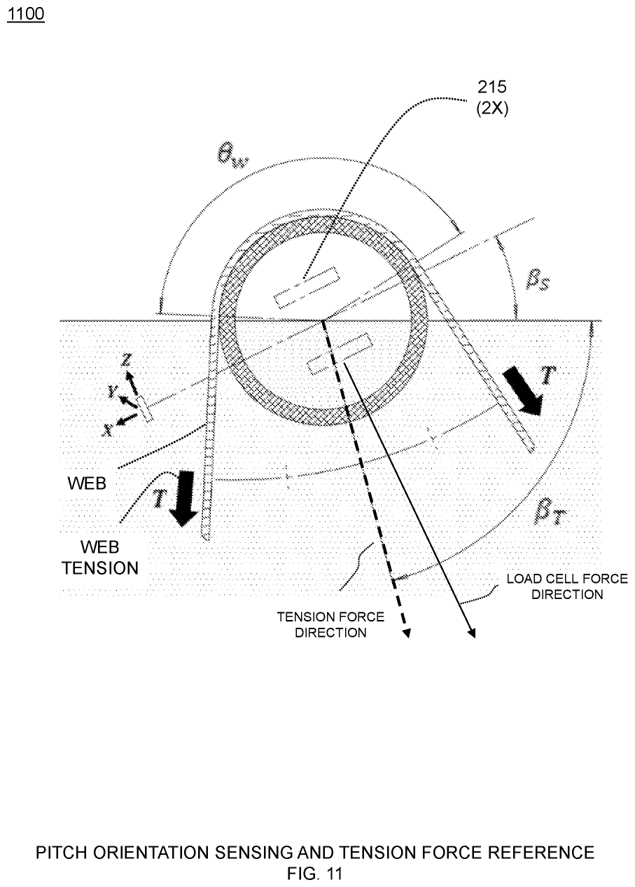

FIG. 11 depicts alignment for pitch orientation 1100. To understand the criticality of the alignment angle value in orientation alignment, take for example, the Tension force direction shown in FIG. 11 which is determined by the wrap angle θw/2. As shown, it does not align with the load cell force direction. Although the misalignment is not extreme, the resulting force measured in the system will not be maximized in-terms of sensitivity of the mechanical-electrical beam assembly even with a small misalignment. The force measurement in the system is represented by the equation:

$$F = 2 T sin ( \frac{{θ}_{w}}{2} ) sin ( {β}_{S} + {β}_{T} ) + W cos ( {β}_{S} ) \qquad Eq . 1$$

FIG. 11 depicts variables where T is web tension, θw is the wrap angle, βs is the pitch angle, and βτ is the force direction angle. As the βτ angle is larger than the intended alignment with the Load cell Force direction vector, the resultant force measured by the system will be smaller with respects to web tension. At small angle misalignments the result may be non-ideal, and, as with larger misalignments, the difference in intended force measurement and actual force measurement may be a cause for tension measurement errors which are unacceptable. In this orientation the X-axis is parallel with the transducer load cell beams 215, and the Z-axis of acceleration is normal to the established X-axis.

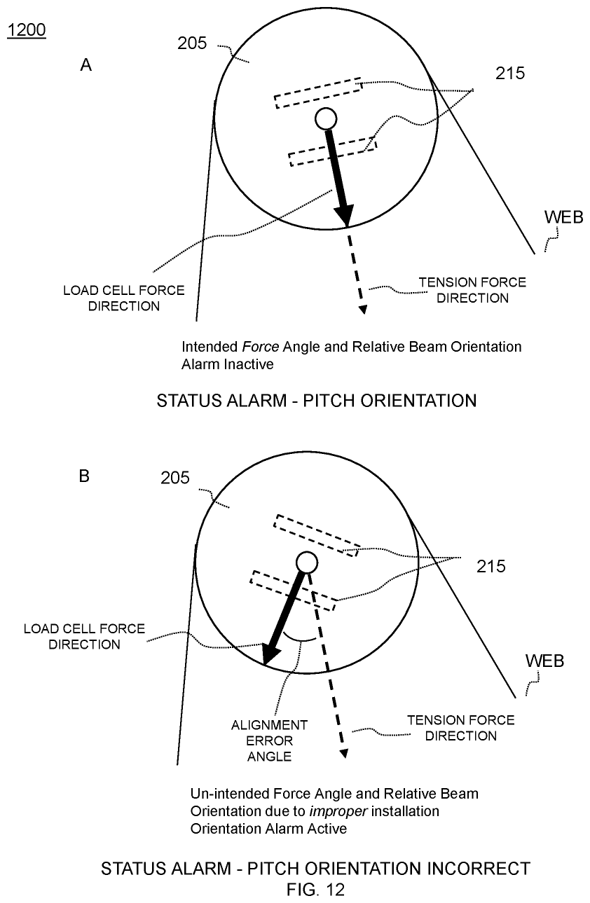

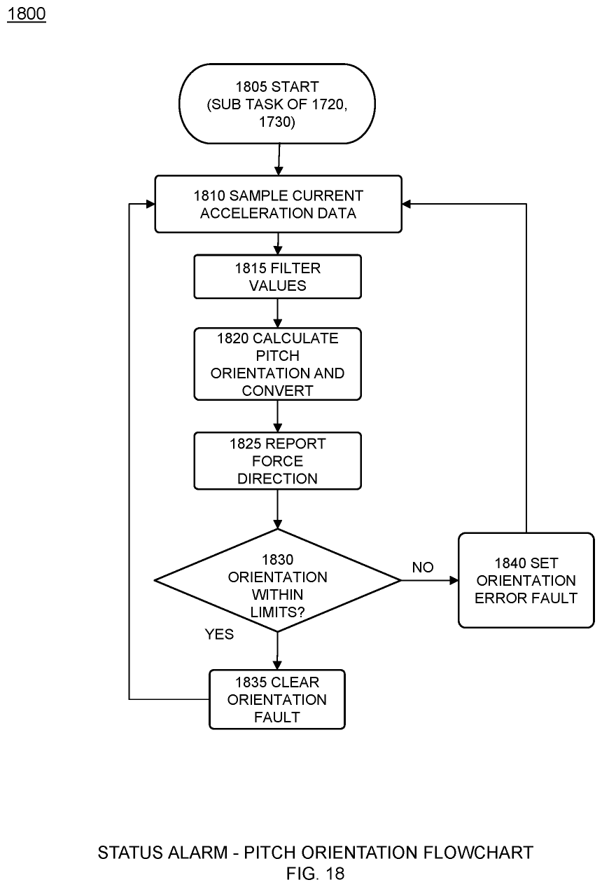

FIG. 12 depicts load cell status alarm pitch reference diagrams 1200. Scenario A demonstrates a condition where a tension roll 205 is installed correctly such as the load cell force direction is aligned with the tension force direction. This proper orientation will allow the maximum force sensitivity, which is ideal. Forces are depicted in relation to roll 205 and transducer load cell beams 215. Scenario B demonstrates a condition where a similar tension roll assembly may have been replaced in a machine with a Load Cell Force direction which does not match or align with the intended tension force direction. In this case, a flag would be set for an orientation alarm if the Alignment error angle exceeds the error limit designated by the system. (Flow chart FIG. 18 will show the method in which an alarm condition can be set or cleared.)

FIGS. 13-16 depict block diagrams/schematics for embodiments.

FIG. 13 is an embodiment wiring diagram schematic 1300. Power supply 1305 interfaces with transducer load cell with integrated data interface 1310 by power connection 705. Data interface 1315 links to transducer load cell with integrated data interface 1310 by data connection 630. Passive side connector 805 of passive transducer load cell 1320 links to transducer load cell with integrated data interface 1310 by active side connector 625. External connections 1325 are needed in embodiments in which the customer provides the roll assembly.

As was presented and illustrated in FIGS. 9-12, orientation is critical to the operation of the Tension Load cell, as the signal is derived from stress in the beams which is related to not only tension in the web but also the orientation in which the web applies force to the roll and beam assembly. This relationship between the web tension force and the load cell beam should always be close to normal to attain maximum tension sensitivity.

When a Transducer Load cell roll is installed, if the orientation is not set correctly then the performance of the transducer load cell will be less than ideal and can affect system performance. It is up to the machine builder to assemble the system such that the load cell force direction is aligned with the Tension force of the web. The load cell force direction is determined by the beam structure of the transducer load cell; the most sensitive orientation is when the force is applied normal to the parallel beams. Once built, the transducer load cell is marked with an arrow to denote Force direction.

As mentioned, the load cell Tension force direction is determined by the web and more specifically, the web wrap angle. The web tension force can be resolved by defining the tension wrap angle C (FIG. 9). At which C/2, the Tension force direction, is established. For a proper installation, the Tension force of the web shall always align in the direction of the transducer load cell force direction indicator. This is usually accomplished by manually measuring angles or estimating the approximate angle of the force direction relative to the wrap angle. This method of orientation for tension force alignment could be improved, and made less error prone if the transducer load cell could measure its inherent orientation and provide feedback such as to indicate if the orientation were set correctly. Furthermore, the underlying reason for misalignment may be inadvertent due to maintenance, repair, or machine re-location. In this case the misalignment would be unexpected and end users would benefit from an orientation alarm or signal.

A transducer load cell device with an integrated data interface which could determine its own orientation with respect to a designated force direction and in addiction could trigger an alert to the condition. This would enable machine builders to verify correct orientation of the load cell and would improve the likelihood that the device can be installed correctly and in adherence with the machine design specification for tension force.

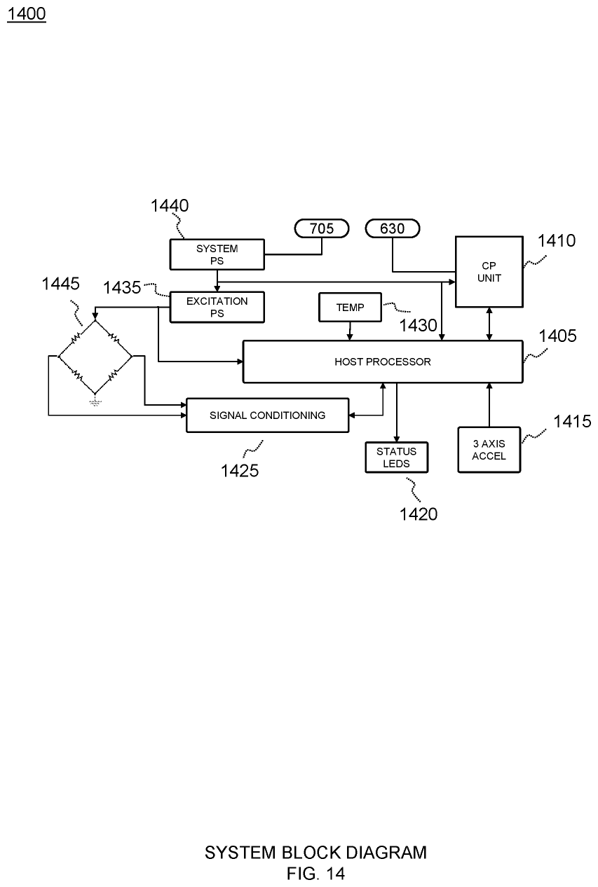

FIG. 14 shows the Load cell connectivity to the signal conditioning block 1400 in which the analog voltage is converted to a digital value and processed by host processor 1405. The converted value is, in part, validated by testing the data interface between the signal conditioning block and host processor 1405. Inputs to host processor 1405 comprise communications processor card 1410, 3-axis accelerometer 1415, status LED 1420, signal conditioning 1425, temp 1430, and excitation power supply 1435. System power supply 1440 provides power to excitation power supply 1435. Bridge 1445 receives power from excitation power supply 1435 and provides input to signal conditioning 1425. System power supply 1440 connects to power connection 705, and communications processor card 1410 connects to data connection 630. Under certain industrial environments where electromagnetic interference can be a cause of communication interference it is useful to devise a method in which to validate the signal from the ADC.

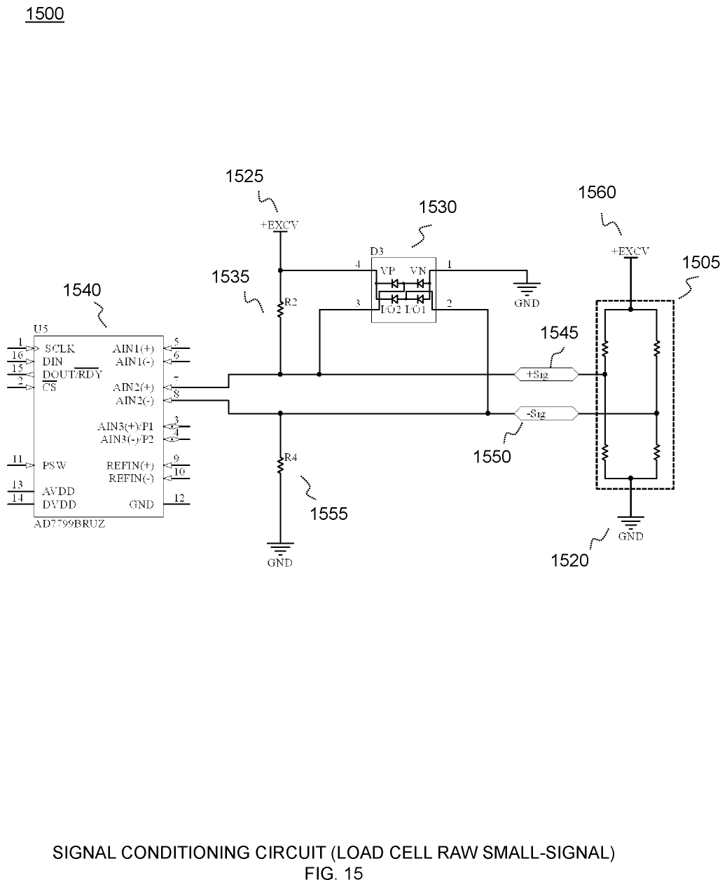

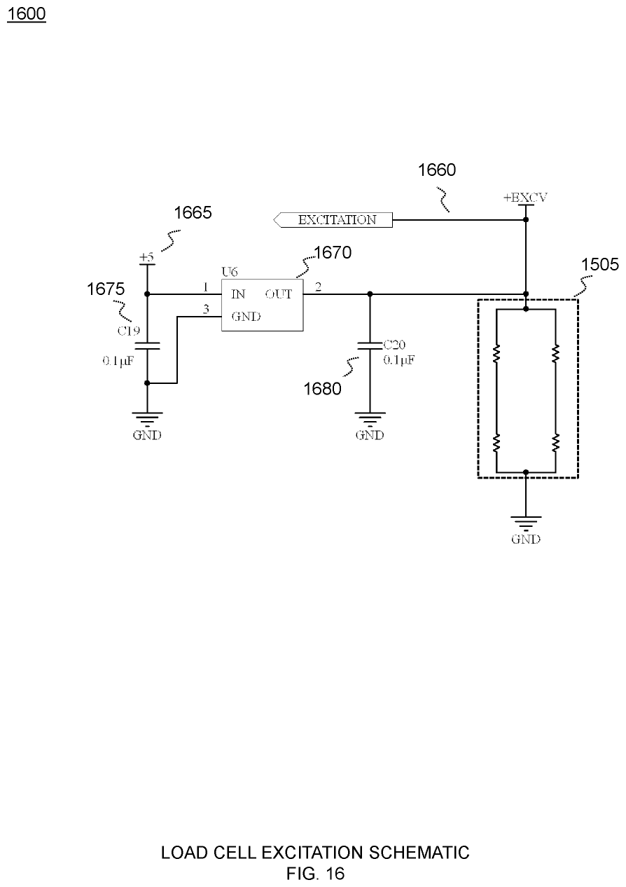

FIG. 15 is a simplified schematic diagram of the load cell interface. A strain gauge bridge 1505 is connected in typical full bridge configuration. A positive sense terminal signal connection 1545 and a negative sense terminal signal connection 1550 are connected as shown. The strain gauge bridge 1505 is excited with an excitation signal +EXCV 1525 which is sourced from current limited regulator (as seen in FIG. 16, 1670). Mechanical stress or force on strain gauges bridge 1505 is converted to a change in voltage which can be monitored at the positive sense terminal signal connection 1545 and the negative sense terminal signal connection 1550. When the bridge is said to be balanced, meaning no stress is applied to the strain gauge assembly, a near zero potential is produced between positive sense terminal signal connection 1545 and a negative sense terminal signal connection 1550 and said connections have a potential relative to GND 1520 to be equal to approximately ½ the +EXCV voltage. A weak pull-up resistor (R2) 1535 is used to bias the signal line positive sense terminal signal connection 1545. A weak pull-down resistor (R4) 1555 is used to bias the signal line negative sense terminal signal connection 1550.

Analog to Digital Converter (ADC) 1540 is utilized to sample and convert the strain gauge signal voltage. ADC 1540 allows bipolar input in the range of GND to +EXCV which allows the strain gauges to measure tension in the direction of the force direction but also in the direction directly opposite to the force direction in case of a 180-degree force direction misalignment. This is a convenience to the customer because sometimes force direction can be misinterpreted by 180 degrees during installation. Often, when the force direction 180-degree misalignment is discovered, the tension load cell roll is already installed in a machine frame. With bi-polar capability implemented at the ADC 1540, the customer is not required to re-install the tension roll to reverse the signal polarity at the positive sense terminal signal connection 1545 and a negative sense terminal signal connection 1550.

External voltage surges or static discharge are a regular event in the industrial environment and the risk of equipment damage must be mitigated within the load cell input circuitry specifically to the ADC 1540 as seen in FIG. 15. This protection is provided to the input circuit specifically pertaining to electrostatic discharge protection, in which the protection is enabled by utilizing a Transient Voltage Suppressor (TVS) 1530 placed on the Signal line's positive sense terminal signal connection 1545, and the negative sense terminal signal connection 1550 which shunt excess voltage to the excitation supply rails 1525 and the GND.

As can be seen in FIG. 15, a weak pull-up resistor (R2) 1535 is used to bias the signal line positive sense terminal signal connection 1545 to be pulled to the +EXCV rail 1525 when a connection is disrupted due to a failed connection to the load cell strain gauge bridge 1505. In the open circuit condition, the node at the positive sense terminal signal connection 1545 fails to connect the load cell strain gauge bridge 1505, and can be considered an open circuit such that no valid signal can be sampled from the load cell strain gauge bridge 1505. Self-diagnosis of an open circuit is possible because the weak pull-up resistor 1535 forces a potential voltage difference between the connected balanced part of the bridge which exists at the negative sense terminal signal connection 1550 node. This large potential, which exists only during a failure condition, is converted by ADC 1540 to a digital value in which a host processor 1405 reads the value and identifies a range limited condition which can solely be correlated to an open circuit connection.

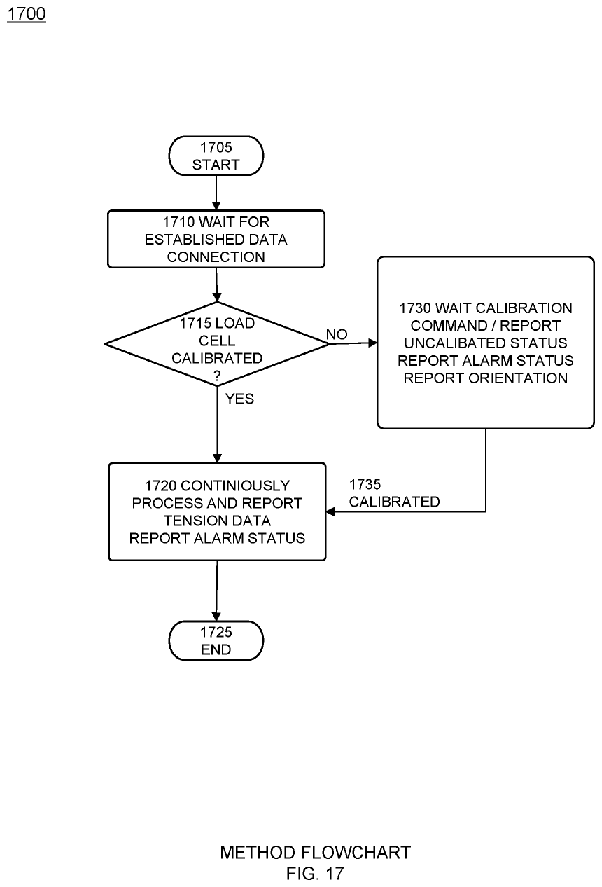

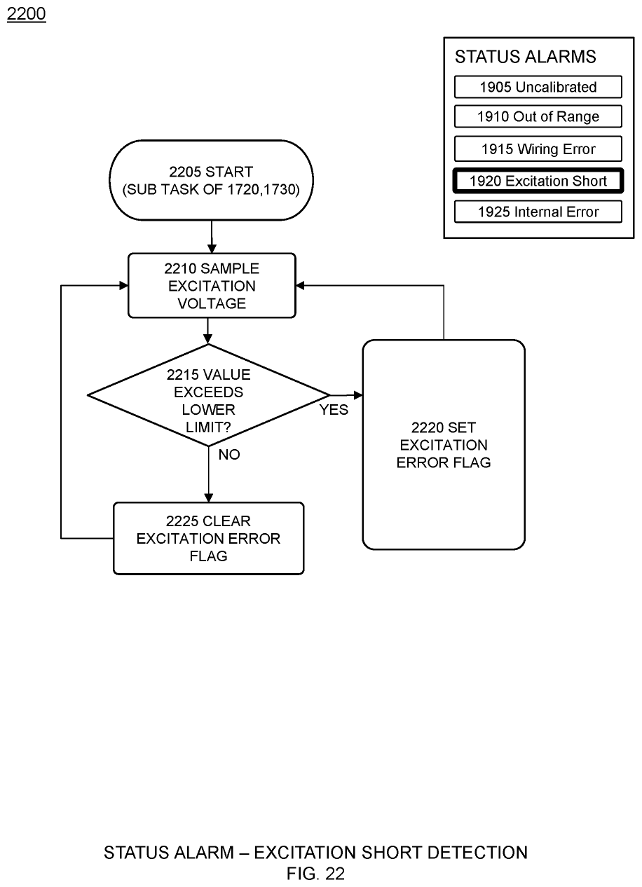

FIG. 16 shows a simplified schematic load cell strain gauge bridge 1505 connected to the +EXCV 1660 node, also known as the excitation voltage for the bridge. The voltage on the +EXCV 1660 rail is monitored at the host processor FIG. 14, 1405 for a low voltage condition. The correlation between low voltage at the FIG. 16 +EXCV 1660 node and an excitation short is established (as identified the flow chart in FIG. 22). The condition is monitored continuously from either state of continuously processing and reporting sensor data/status (FIG. 22, 2220) or waiting for an established data connection (FIG. 22, 2210 as also seen in FIG. 17). The error flag is set when the value exceeds the lower static limit which shall identify a fault. The cause may be the case where a mechanically damaged strain gauge, or a wiring fault, or alternately by a condition of conductive pollution on the strain gauge assembly. In this condition, the power sourced from excitation voltage regulator 1670 will apply a current limit as the device enters a protective shutdown mode. This current regulation and protected shutdown will prevent a brownout of the +5Volt power rail 1665, thus preventing the device from losing host processor power, and enabling self-diagnosis of the condition with reporting of the error flag through the data interface. Also depicted are capacitor C19 1675 between input and ground of excitation voltage regulator 1670 and input to load cell strain gauge bridge 1505, and capacitor C20 1680 between output of excitation voltage regulator 1670 and input to load cell strain gauge bridge 1505. In embodiments, each of capacitors C19 1675 and C20 1680 is a 0.1 μF capacitor.

FIGS. 17-23 are flowcharts depicting methods for embodiments.

FIG. 17 is a flowchart illustrating a method 1700 for obtaining tension data from a device in accordance with embodiments of the present invention. In one embodiment, the method comprises gathering sensor data designed to indicate tension with respect to the current material being run over the device. The tension data availability is dependent on the state of the device being calibrated and the presence of an established data connection. Embodiment steps comprise starting 1705; waiting for an established data connection 1710; determining if the load cell calibrated 1715; if yes, continuously process and report sensor data and alarm status 1720; and ending 1725; if no, await calibration command/report uncalibrated status 1730; then, when calibrated 1735, continue on to continuously process and report sensor data/status 1720.

FIG. 18 is a status alarm—pitch orientation flow chart 1800. As mentioned in FIG. 12, the FIG. 18 flow chart shows the method in which an alarm condition can be set or cleared which would indicate and alert to an orientation fault. This method is a sub-task of step 1720 (continuously process and report sensor data and alarm status) and/or step 1730 (await calibration command/report uncalibrated status) of FIG. 17. In one embodiment, the accelerometer data is sampled from a tension calibrated system state 1720 or an uncalibrated system state 1730. This allows orientation status and flags to be passed via the data network to the attached system for analysis independent of the tension calibration condition. Method embodiments start 1805 as a subtask of a tension calibrated system state 1720 or an uncalibrated system state 1730. Current acceleration data is sampled 1810; sampled acceleration values are then filtered 1815. The filter block applies a digital low pass filter to the raw acceleration signal data. This filter is applied to filter out machine vibration and other environmental vibration to which the device is subjected. Filtered acceleration values are then then used to calculate pitch orientation 1820, which is converted to load cell force direction orientation. The orientation is compared to limits 1830 which are stored in data registers. If the load cell force direction orientation is within limits, an orientation fault is cleared 1835, and current acceleration data is (re)sampled 1810. If the load cell force direction orientation is not within limits, an orientation fault is set 1840, and current acceleration data is (re)sampled 1810.

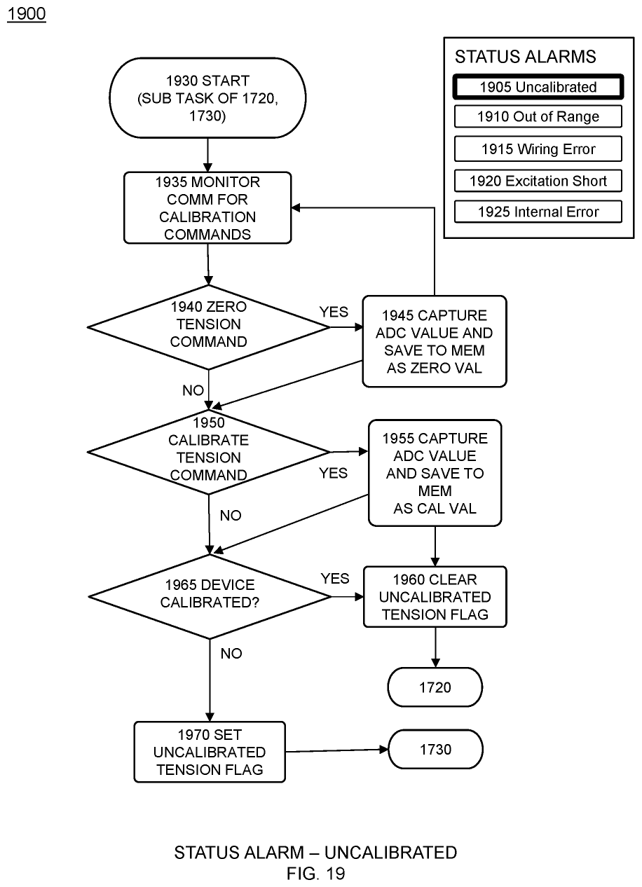

FIG. 19 depicts a Status Alarm—Uncalibrated method flowchart 1900. Embodiments comprise five Status Alarms: Uncalibrated 1905; Out of Range 1910; Writing Error 1915; Excitation Short 1920; and Internal Error 1925. The method starts 1930 as a subtask of system state 1720 and 1730 defined in FIG. 17. The Uncalibrated status 1905 is reported in the Status Alarm data which alerts the higher-level connected system such as a connected Programmable Logic Controller (PLC) via the data interface (data interface connectors 305, 630) that no tension data is available due to an Uncalibrated state. FIG. 19 illustrates the method in which the Uncalibrated state is determined and reported, as well as monitoring for calibration commands. The method starts 1930 from the uncalibrated state (FIG. 17, 1730), and the calibrated state (FIG. 17, 1720). The commands for calibration are continuously monitored 1935 by communications processor card 1410. As in two-point calibration methods, the value for zero 1945 must be established as well as a second point of calibration 1955. These data points in this embodiment are identified as the zero and the calibration point. Typically, the tension transducer load cell 1310 will have no weight applied to it when the zero command 1940 is taken to establish the first calibration point. Monitoring step 1930 monitors communications for commands, including a zero tension command 1940 and a calibrate tension command 1950. At step 1940 the communications check for a (determine) zero tension command. If there is a (determine) zero tension command, the Analog to Digital Converter (ADC) value is captured (from ADC 1540), and is saved to memory 1945 to establish the zero value point of the two-point calibration. If there is no (determine) zero tension command, the method continues to step 1950. At step 1950, the communications check for a (determine) calibrate tension command. The calibration procedure instructs that a calibration weight must be applied to the tension load cell before the calibrate tension command is issued from the higher-level connected system such as a connected Programmable Logic Controller (PLC). When the command is received, the command is processed to establish the second point 1955 of calibration. The ADC value is captured (from ADC 1540), and is saved to memory 1955 to establish the calibration value point of the two-point calibration. The calibration weight applied to the tension load cell to establish the second point 1955 of calibration is usually 10% of the total range to be measured to maintain the critical tolerances for performance and also serves as a method allowing calibration weights to be sized at a fraction of full tension range which can reduce the need for hanging extremely heavy weights for larger range calibrations. A valid calibration is determined by the condition of having both a valid zero value and a valid calibration value stored in memory. The memory is examined in step 1965 for this condition. Valid conditions are determined by their existence, and also their proximity to one another in terms of data value. More specifically, the memory is probed for condition checks to determine if the zero value and calibration value are appropriately distanced from one another in terms of value. If a proper, adequate, calibration weight for tension was hung during the calibration process, then the values would be sufficiently separated in a value by a defined amount from one another, and thus a valid calibration can be concluded. If the device is affirmatively calibrated, the Uncalibrated tension flag is cleared 1960, indicating that the system is calibrated and the system state returns to the step of continuously processing and reporting sensor date/status (FIG. 17, 1720). If the device is not calibrated at 1965, such as in the case that an improperly small weight was hung for the calibration process, or that a portion of the calibration process was not preformed, then the condition is recognized when the memory is probed for condition checks to determine if the zero value and calibration value are appropriately defined and/or distanced from one another in terms of value. In a case where the conditional checks yield false results, the calibration would be considered invalid, and the Uncalibrated tension flag is set to indicate the system state is Uncalibrated and the system state returns to await calibration command/report Uncalibrated status (FIG. 17, 1730). Additionally, it should be noted that from the state of continuously processing and reporting sensor data/status (FIG. 17, 1720), the subtask 1930 would run allowing the device to be recalibrated as machine conditions change, or the system is re-commissioned, serviced, or otherwise altered in a way which requires re-calibration.

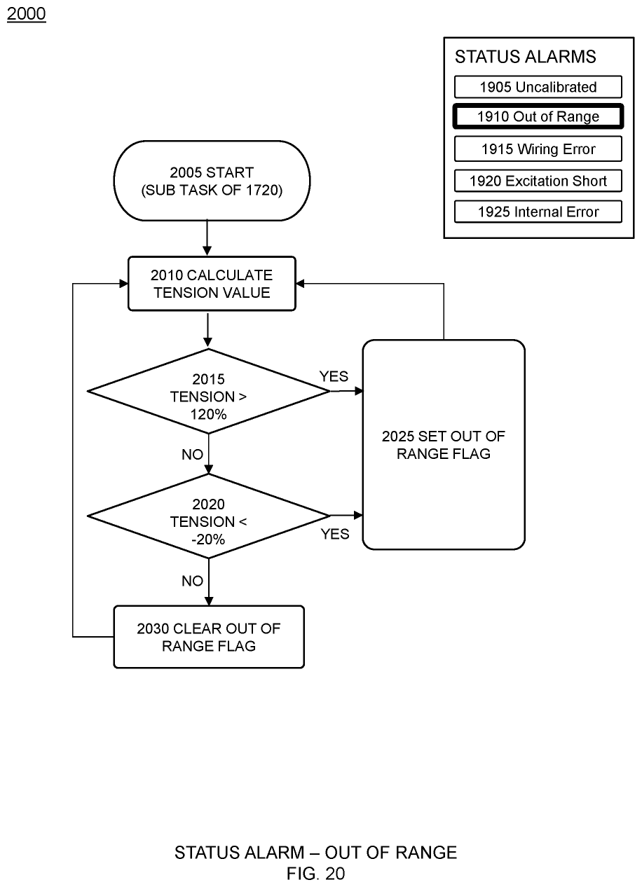

FIG. 20 depicts an Out of Range Status Alarm method flowchart 2000. It presents an Out of Range condition 1910 of the five Status Alarms. The method starts 2005 as a subtask of system state 1720 defined in FIG. 17. 1720 is the calibrated state that comprises continuously processing and reporting sensor data/status. The tension value is calculated 2010 in host processor 1405, and then checked to see if the value exceeds 120% of the full range calibrated value 2015. If YES, the flag for an out of range condition is set 2025. If NO, the tension value is then again checked to see if it exceeds the value of −20% of the full range calibrated value 2020. If YES, the flag for Out of Range is set 2025. The flag for out of range will clear 2030 upon the condition that the previous range checks results are NO, indicating that the out-of-range condition is no longer present.

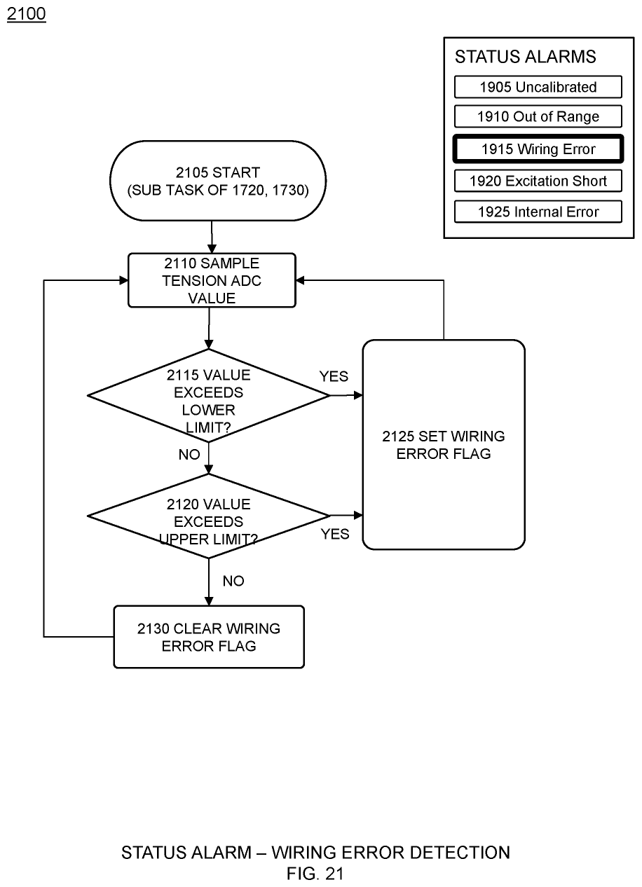

FIG. 21 depicts a Status Alarm—Wiring Error method flowchart 2100. It presents a Wiring Error condition 1915 of the five Status Alarms. The method triggers the Wiring Error Alarm from an open circuit condition (FIG. 15 circuit). The method starts 2105 as a subtask of system states 1720 and 1730 defined in FIG. 17. ADC tension values are sampled 2110. The value is then compared to the lower limit range of the expected signal 2115. The lower limit value is established and known to be the threshold value which cannot otherwise be reached in conditions other than a wiring fault or open circuit event. This is because the bridge 1505 is naturally balanced due to the arrangement of semiconductor strain gauges in a Wheatstone bridge configuration. The strain gauges can only influence the voltage measured at node 1545 and 1550 in a limited manner. When connected schematically as described in FIG. 15, they would not be able to produce voltages considered to be ‘close to the rails’ of the Excitation voltage 1525 or the GND potential 1550. However, if the circuit is experiencing an open circuit condition, this threshold could be exceeded. If the value exceeds the lower limit, then the Wiring Error Status Alarm flag is set 2125. This would occur, for example, if the circuit had an open or disconnected wire to the excitation source 1560. In this case, the signal voltage measured by ADC 1540 would be pulled low by the dominant lower half of the strain gauge bridge 1505 because the bridge resistors are lower in ohmic value than the bias resistors. Thus producing a value that exceeds the lower threshold for normal operation. When this lower threshold is exceeded, the wiring error flag is Set 2125, and the state proceeds to re-sampling Tension ADC values 2110. If the lower limit is not exceeded in 2115, then an additional threshold check is processed for the upper value 2120 where, if the value exceeds the upper limit, then the Wiring Error Status Alarm flag is set 2125. This would occur, for example, if the circuit had an open node at 1545 or 1550. In this case, only one-half side of the bridge would be biasing the connected node at approximately ½ the Excitation voltage. Where the other unconnected node would be biased appropriately to force the upper limit trigger threshold detection. For instance, if node 1545 was disconnected, the bias resistor R2 1535 would dominate the node and force the node 1545 to the excitation rail 1525 potential, while the other input of the ADC 1540 would still be tied to one side of the strain gauge bridge 1505 the potential as measured at the AIN2(+) and AIN2(−) terminals of the ADC 1540 would exceed the upper level threshold because of the large positive input differential signal, much larger than standard strain gauge bridge signals. The same condition holds true if the node 1550 is disconnected. As in the previous condition, a large potential will develop at the AIN2(+) and AIN2(−) terminals of the ADC 1540 due to the GND bias on the unconnected 1550 node. More specifically, in this condition the terminal AIN2(−) will be pulled to GND and the AIN2(+) terminal will be held at balanced half bridge voltage of approx. ½ Excitation. This again is a large positive input differential signal much larger than standard strain gauge bridge signals. If neither limit is exceeded, the wiring error flag is cleared 2130, and the process repeats indefinitely as a subtask of the system states 1720 and 1730 defined in FIG. 17.

FIG. 22 depicts a Status Alarm—Excitation Short detection method flowchart 2200. It presents an Excitation Short condition 1920 of the five Status Alarms. The method starts 2205 as a subtask of system states 1720 and 1730 defined in FIG. 17. An Excitation Short is established through sampling 2210 the excitation voltage at FIG. 16 +EXCV node 1660 via host processor 1405. The sampled excitation voltage is then compared to determine if it exceeds a lower limit 2215. The lower limit would typically be just below the standard tolerance of voltage regulation provided by the excitation voltage regulator 1670. The stability of the regulator is not ultra-critical as all measurements are radiometric in nature, however there is still a need for general fault detection. Typical faults causing the excitation voltage to violate a lower limit threshold would be excessive loading of the strain gauge excitation net due to shorts, crushed wires, or general incorrect wiring. Other examples may include the failure of the excitation regulator. In any case, if the voltage exceeds the lower limit, the Excitation Short error flag is set 2220, and the steps return to sampling excitation voltage 2210. If it does not exceed the lower limit, the Excitation Short error flag is cleared 2225, and the steps return to sampling excitation voltage 2210. The condition is monitored continuously from either state of continuously processing and reporting sensor data/status 1720 or await calibration command/report uncalibrated status 1730 as seen in FIG. 17.

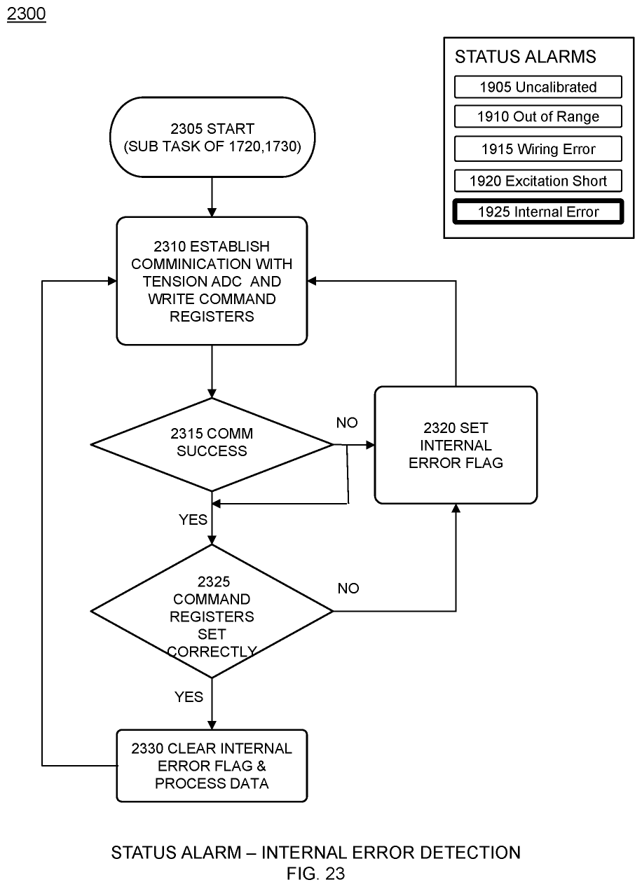

FIG. 23 depicts an Internal Error Status Alarm method flowchart 2300. It presents an Internal Error condition 1925 of the five Status Alarms. The method starts 2305 as a subtask of system states 1720 and 1730 defined in FIG. 17. The method comprises attempted communication with the tension ADC and the configuration of the ADC Write Command registers' operating parameters 2310. The process is run from the calibrated or uncalibrated states. Communication success is evaluated, and the determination is made as to whether or not communication is successful 2315. If communication is not successful, an internal error condition is present, and the flag for internal error is set 2320, then steps return to 2310. If communication is successful, the command registers, which serve as a unique configuration signature, are queried to see if they are set correctly 2325. Because, at power up, the command registers of the ADC are set to the default factory state, successful verification of the proper values can be determined. If it is concluded that that successful and valid communication between the host processor and the ADC is occurring, any flags for internal errors are cleared and data is processed 2330. If the command register does not match the programed configuration, an error condition is present, and the flag for internal error is set 2320. After data is processed without error 2330, the state proceeds to continue to re-establish communication, and process the next tension data sample 2310, and the interface integrity continues to be verified and validated as the method repeats continuously.

The foregoing description of the embodiments of the invention has been presented for the purposes of illustration and description. It is not intended to be exhaustive or to limit the invention to the precise form disclosed. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure. Other and various embodiments will be readily apparent to those skilled in the art, from this description, figures, and the claims that follow. It is intended that the scope of the invention be limited not by this detailed description, but rather by the claims appended hereto.

What is claimed is:

1. A tension transducer load cell device with an integrated data interface for remote calibration and monitoring comprising:
a host processor (1405);
at least one strain gauge (225, 505) comprising a bridge (1445, 1505);
an excitation power supply (1435);
a 3-axis accelerometer (1415), whereby load cell force direction orientation is measured;
an Analog to Digital Converter (ADC) (1540); and
a signal conditioning circuit assembly (230, 1425, 1500);
wherein load cell beams (215) have an induced stress in a structure of said beams which is measured using said at least one strain gauge (225, 505) which, in turn, generate a signal coupled to said signal conditioning circuit assembly (230, 1425, 1500);
wherein integration of signal conditioning allows for reduced system infrastructure within said tension transducer load cell device;
no external amplifier is employed for said tension transducer load cell;
remote monitoring of said tension transduce load cell for error conditions is provided directly through said integrated data interface, with no reliance on external amplifier hardware;
wherein additional integrated sensor information is sampled and made available over said data interface; and
whereby said remote calibration and monitoring and diagnostic results are provided.

2. The tension transducer load cell device of claim 1, wherein said device further comprises:
a roll (205, 515);
bearings (210) on which said roll is mounted;
load cell beams (215);
means for holding said beams;
a rigid shaft (220); and
a mechanical fixed mounting.

3. The tension transducer load cell device of claim 1, wherein said tension transducer load cell is a web tension transducer load cell.

4. The tension transducer load cell device of claim 1, wherein said host processor (1405) executes a method for storing and retrieving calibration data from a memory storage device; and
applies this calibration data to a raw load cell signal, producing a calibrated tension value.

5. The tension transducer load cell device of claim 1, wherein said signal conditioning circuit assembly (230, 1425, 1500) comprises:
a Transient Voltage Suppressor (TVS) (1530);
a positive sense terminal signal connection (1545); and
a negative sense terminal signal connection (1550); and
a communication processor (1410) and data interface to transfer calibrated tension data over a data connection.

6. The tension transducer load cell device of claim 1, wherein sensors of said device provide remote monitoring of said load cell for error conditions directly through said data interface, with no reliance on external amplifier hardware;
said remote monitoring comprising:
an uncalibrated status alarm (1900);
an out-of-range status alarm (2000);
a writing error status alarm (2100);
an excitation short status alarm (2200); and
an internal error status alarm (2300).

7. The tension transducer load cell device of claim 1, wherein additional integrated sensors provide information pertinent to a web process is sampled and made available over said data interface, said additional integrated sensor information comprising:
said load cell force direction orientation;
internal temperature;
excitation voltage; and
raw load cell small-signal output voltage.

8. The tension transducer load cell device of claim 1, wherein load cell calibration comprises a calibration weight about 10% of a total range to be measured.

9. The tension transducer load cell device of claim 1, wherein said signal conditioning circuit assembly (230, 1425, 1500) comprises a Wheatstone bridge.

10. A tension transducer load cell method with an integrated data interface for remote calibration and monitoring comprising:
providing a tension transducer load cell device comprising:
a host processor (1405);
at least one strain gauge (225, 505) comprising a bridge (1445, 1505);
an excitation power supply (1435);
a 3-axis accelerometer (1415), whereby load cell force direction orientation is measured;
an Analog to Digital Converter (ADC) (1540);
a signal conditioning circuit assembly (230, 1425, 1500); and
a communication processor (1410) and data interface to transfer calibrated tension data over a data connection;
wherein load cell beams (215) have an induced stress in a structure of said beams which is measured using said at least one strain gauge (225, 505) which, in turn, generate a signal coupled to said signal conditioning circuit assembly (230, 1425, 1500);
wherein integration of signal conditioning allows for reduced system infrastructure within said system;
no external amplifier is employed for the tension transducer load cell;
remote monitoring of said tension transducer load cell for error conditions is provided directly through said integrated data interface, with no reliance on external amplifier hardware;
said remote monitoring comprising:
an uncalibrated status alarm (1900);
an out-of-range status alarm (2000);
a writing error status alarm (2100);
an excitation short status alarm (2200); and
an internal error status alarm (2300);
whereby said remote calibration and monitoring and diagnostic results are provided.

11. The tension transducer load cell method of claim 10, wherein said uncalibrated status alarm (1900) comprises:
continuously monitoring commands for calibration (1935) by communications processor card (1410);
monitoring communications for a determine zero tension command (1940);
if there is a determine zero tension command, an ADC value is captured from said ADC (1540), and is saved to a memory (1945) to establish a zero value point;
monitoring said communications for a calibrate tension command (1950);
when said calibrate tension command is received, said calibrate tension command is processed to establish a second point (1955) of calibration, said calibrate tension value is captured from said ADC (1540), and is saved to memory (1955) to establish a calibration value point of a two-point calibration;
if said tension transducer load cell is affirmatively calibrated, an Uncalibrated tension flag is cleared (1960);
examining memory for a calibrated condition (1965); and
if said tension transducer load cell is not calibrated, said Uncalibrated tension flag is set (1970).

12. The tension transducer load cell method of claim 10, wherein said out-of-range status alarm (2000) comprises:
calculating a tension value (2010) in host processor (1405);
checking to see if said tension value exceeds 120% of a full range calibrated value (2015);
if yes, a flag for an out of range condition is set (2025);
if no, said tension value is again checked to see if it exceeds a value of −20% of a full range calibrated value (2020);
if yes, said flag for out-of-range is set (2025);
said flag for out of range clears (2030) upon a condition that previous range checks results are no, indicating that an out-of-range condition is no longer present.

13. The tension transducer load cell method of claim 10, wherein said writing error status alarm (2100) comprises:
sampling ADC tension values (2110);
comparing said ADC tension values to a lower limit range of an expected signal (2115);
checking an additional threshold for an upper value (2120);
if said value exceeds an upper limit, then a Wiring Error Status Alarm flag is set (2125);
if said value does not exceed said upper limit, then said Wiring Error Status Alarm flag is cleared (2130).

14. The tension transducer load cell method of claim 10, wherein said excitation short status alarm (2200) comprises:
sampling an excitation voltage at a +EXCV node via said host processor (2210);
comparing said sampled excitation voltage to determine if it exceeds a lower limit (2215);
if said sampled excitation voltage exceeds a lower limit, an Excitation Short error flag is set (2220), and steps return to said sampling excitation voltage (2210);
if said sampled excitation voltage does not exceed said lower limit, said Excitation Short error flag is cleared (2225), and steps return to said step of sampling excitation voltage (2210).

15. The tension transducer load cell method of claim 10, wherein said internal error status alarm (2300) comprises:
attempting communication with said ADC and a configuration of an ADC Write Command registers' operating parameters (2310);
determining whether or not said communication is successful (2315);
if said communication is not successful, an internal error condition is present, and a flag for internal error is set (2320), then steps return to step (2310);
if communication is successful, said ADC command registers, which serve as a unique configuration signature, are queried to see if they are set correctly (2325);
if successful and valid communication between said host processor and said ADC is occurring, any flags for internal errors are cleared and data is processed (2330).

16. The tension transducer load cell method of claim 10, wherein said method measures a cantilevered roll.

17. The tension transducer load cell method of claim 10, wherein load cell calibration measurement comprises a calibration weight about 10% of a total range to be measured.

18. The tension transducer load cell method of claim 10, wherein additional integrated sensor information pertinent to a web process is sampled and made available over said data interface, said additional integrated sensor information comprising:
a load cell force direction orientation;
an internal temperature;
an excitation voltage; and
a raw load cell small-signal output voltage.

19. The tension transducer load cell method of claim 10, wherein force measurement is represented by:
$$F = 2 T sin ( \frac{{θ}_{w}}{2} ) sin ( {β}_{S} + {β}_{T} ) + W cos ( {β}_{S} )$$
where T is web tension, θω is a wrap angle, βs is a pitch angle, and βτ is a force direction angle.

20. A web tension transducer load cell system with an integrated data interface for remote calibration and monitoring comprising:
a host processor (1405);
at least one strain gauge (225, 505) comprising a bridge (1445, 1505);
an excitation power supply (1435);
a 3-axis accelerometer (1415), whereby load cell force direction orientation is measured;
an Analog to Digital Converter (ADC) (1540);
a signal conditioning circuit assembly (230, 1425, 1500) comprising:
a Transient Voltage Suppressor (TVS) (1530);
a positive sense terminal signal connection (1545); and
a negative sense terminal signal connection (1550);
a communication processor (1410) and data interface to transfer calibrated tension data over a data connection;
a roll (205, 515);
bearings (210) on which said roll is mounted;
load cell beams (215);
means for holding said beams;
a rigid shaft (220);
a mechanical fixed mounting;
wherein said load cell beams (215) have an induced stress in a structure of said beams which is measured using said at least one strain gauge (225, 505) which, in turn, generate a signal coupled to said signal conditioning circuit assembly (230, 1425, 1500);
wherein integration of signal conditioning allows for reduced system infrastructure within said system;
no external amplifier is employed for said tension transducer load cell;
remote monitoring of said load cell for error conditions is provided directly through said data interface, with no reliance on external amplifier hardware;
said remote monitoring comprising:
an uncalibrated status alarm (1900);
an out-of-range status alarm (2000);
a writing error status alarm (2100);
an excitation short status alarm (2200); and
an internal error status alarm (2300);
wherein additional integrated sensor information pertinent to a web process is sampled and made available over said data interface, said additional integrated sensor information comprising:
a load cell force direction orientation;
an internal temperature;
an excitation voltage; and
a raw load cell small-signal output voltage;
whereby said remote calibration and monitoring and diagnostic results are provided.
